(19) United States
(12) Patent Application Publication
(10) Pub. No.: US 2002/0065083 A1
(43) Pub. Date: May 30, 2002

(54) Method and system for high speed wireless data transmission and reception

(76) Inventor: Rajendra Patel, Chevy Chase, MD (US)

Correspondence Address: SONNENSCHEIN NATH & ROSENTHAL, P.O. Box 061080, Wacker Drive Station, Sears Tower, Chicago, IL, 60606-1080, US

(21) Appl. No.: 09/947,980

(22) Filed: Sep. 6, 2001

Related U.S. Application Data
(60) Provisional application No. 60/230,710, filed on Sep. 7, 2000.

(51) Int. Cl. H04Q 7/20

(52) U.S. Cl. 455/452; 455/509

(57) ABSTRACT

The invention may be broadly conceptualized as an approach in which a wireless device is able to communicate with a management network that is capable of steering a predetermined amount of data to the wireless device over a control channel associated with management network or if the amount data is above a predetermined threshold, the management network sets up a second connection through another network over a payload channel that is associated with another control channel in the other network.

### REFERENCE TO EARLIER-FILED APPLICATION

This application claims the benefit of U.S. Provisional Application No. 60/230,710, entitled “Method and System for High Speed Wireless Data Transmission and Reception,” filed Sep. 7, 2000, which is herein incorporated by reference in its entirety.

### BACKGROUND OF THE INVENTION

1. Technical Field

The invention relates to the management of wireless devices across multiple networks. More particularly, the invention relates to a wireless device communicating with a wireless management network in addition to a voice and/or data wireless network.

2. Related Art

Currently, wireless networks allow devices such as cellular phones, wireless modems and personal digital assistants (PDAs) to operate within a specific wireless network. Each device is dedicated to a predetermined network and has limited ability to roam into other networks. In cellular telephonic networks, roaming across networks has been accomplished by network-to-network communication for handing over the call from one network to another network. The wireless device being handed over has the ability to communicate with the new network in order to set up the voice or payload channel. Further, to facilitate the roaming of wireless devices from one network into another, a number of protocols between wireless networks have been devised, such as MOTOROLA's DMX protocol, IS-41 standard and IS-136 standard. A problem with the current approaches is that the wireless networks must be similar or the wireless devices must be multimode capable (i.e. Digital CDMA and Analog).

A number of wireless Internet services are being developed for access by wireless devices, such as stock quotes and messaging systems. Current wireless networks are designed such that voice/payload channels must be assigned in order for a wireless device to access data stored outside the wireless network. Thus, processing resources and precious bandwidth are required for most data transfers. Some cellular networks, such as a GSM network, have attempted to implement “short message services” that enable relatively small amounts of data to be transmitted to a cellular device over a control channel. But, such implementations are adapted for short text messages rather than accessing the Internet and upon the cellular device switching between networks the service may or may not be provided. Thus, there is a needed in the art for wireless devices to be able to access data services seamlessly across a plurality of wireless networks at greater speeds than currently available.

### SUMMARY

A management network is provided that allows a wireless device to be configured to access a wireless network from a plurality of possible wireless networks. By using an access management channel of the management network, a wireless device is able to receive information associated with accessing another network and data transfers above a predetermined threshold is steered by the management network via the other network. The access management channel may also be configured to provide up to the predetermined amount of data in-band to and from the wireless device using a packet protocol, such as TCP/IP or other packet protocols as appropriate. Further, by using the management network to configure the wireless device, different payload networks may be accessed, such as a private data network during predetermined periods and a cellular network during other periods or when the wireless device is at another locations. The wireless device may also execute an application that accesses a specific network or type of network, such as CDMA, TDMA, GSM or data wireless network.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a block diagram of a wireless access management system 100 in accordance with an embodiment of the invention.

FIG. 2 is a block diagram of WAM network 106 within the wireless access management system 100, of FIG. 1 in accordance with an embodiment of the invention.

FIG. 3 is a message flow diagram 300 of a wireless device 102 initiated a burst mode data transfer in WAM network 106 of FIG. 2 in accordance with an embodiment of the invention.

FIG. 4 is a message flow diagram 400 of an Internet host 312 initiated burst mode data transfer with wireless device 102 in a WAM network 106 of FIG. 2 in accordance with an embodiment of the invention.

FIG. 5 is a message flow diagram 500 of a wireless device 102 initiated acquired bandwidth data transfer in WAM network 106 of FIG. 2 in accordance with an embodiment of the invention.

FIG. 6 is a message flow diagram 600 of an AMC manager 204 initiated acquired bandwidth data transfer in WAM network 106 of FIG. 2 in accordance with an embodiment of the invention.

FIG. 7 is a flow diagram of the process of a wireless device 102 initiating an acquired bandwidth data transfer in WAM network 106 of FIG. 2 in accordance with an embodiment of the invention.

FIG. 8 is a flow diagram of the process of an AMC manager 204 initiating an acquired bandwidth data transfer in WAM network 106 of FIG. 2 in accordance with an embodiment of the invention.

### DETAILED DESCRIPTION OF THE EXEMPLARY EMBODIMENTS

Reference is now made in detail to an embodiment of the present invention, an illustrative example of which is illustrated in the accompanying drawings, showing a system and method for real-time steering of content (data) by an access control management network to or from a wireless device to one of a possible plurality of wireless networks. The data being transported is IP-based Internet data, such as web pages and may be exchanged at a wide range of speeds from several kilobits per second (“Kbps”) to over several megabit per second (“Mbps”) such as two Mbps that is envisioned in third-generation (3G) wireless networks. Further, the data may be in the form of packet data, packet voice data, or circuit voice data. In alternate embodiments, other types of data may be transport to and from the wireless device, such as text data, encrypted data, packet data, or compressed data.

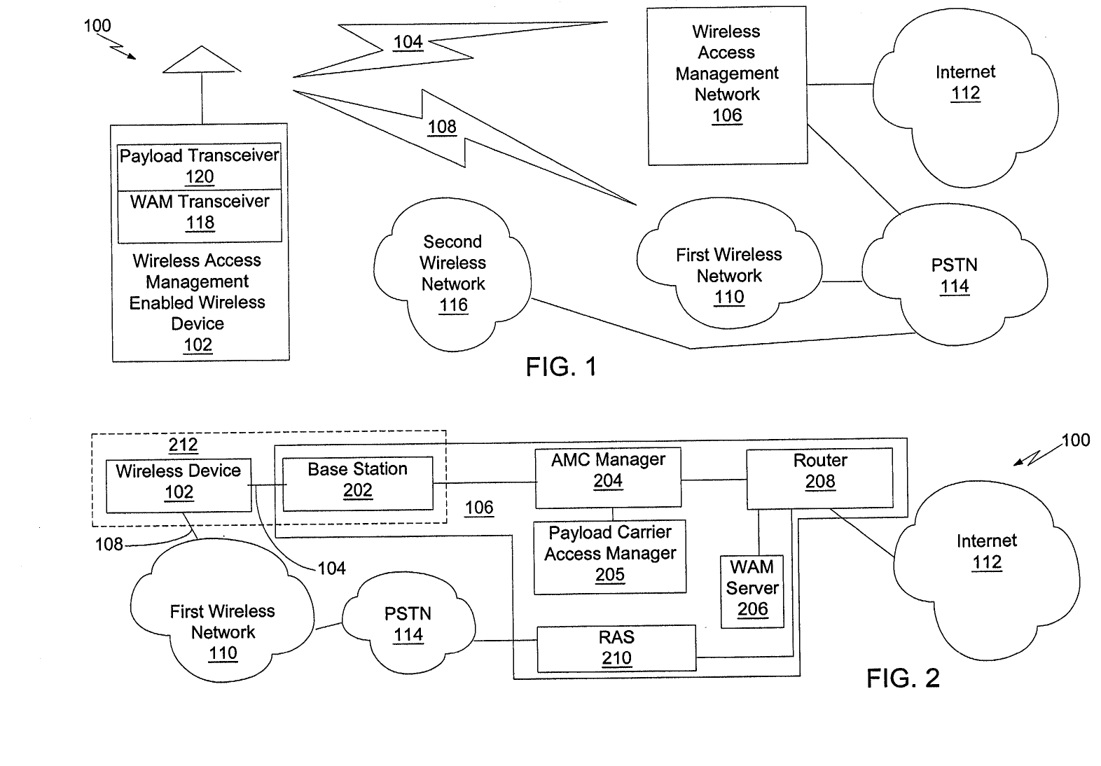

In FIG. 1, a block diagram of a wireless access management system 100 is shown. A wireless device 102 is in communication over an access management channel (AMC) 104 with a wireless access management (WAM) network 106 and over a wireless payload channel 108 with a first wireless network 110. The WAM network 106 is connected to the Internet 112 and a public switch telephone network (PSTN) 114. The PSTN 114 is connected to the first wireless network 110 and a second wireless network 116. The PSTN 114 may be implemented as a public switch network, a private network, a home-based network, a data network, or any combination of the previous types of networks in alternate embodiments of the invention.

The wireless device 102 is able to receive and transmit control information and data through a WAM transceiver 118 with the WAM network 106 over the AMC 104. Further, the wireless device is also able to exchange data and control information through a payload transceiver 120 over the payload channel 108 and control channel associated with the first wireless network 110. Examples of technologies used in the first wireless network 110 or second wireless network 116 include GSM/GPRS and CDMA. The payload transceiver 120 communicates over one or more separate control channels associated with the assigned network (the first wireless network 110 in the FIG. 1) in addition to transferring data over the assigned payload channel 108. In an alternate embodiment, a common tunable transceiver may be used. Examples of some wireless devices that may incorporate a WAM transceiver 118 include cellular telephones, Personal Digital Assistants (PDAs), computers having a wireless modem computer card (PCMCIA card, PCI card) that contains a WAM transceiver, and Internet appliances.

The wireless device 102 also contains a controller, such as a processor, digital signal processor, application specific integrated circuit (ASIC), discrete logic functioning as a state machine, analog circuit functioning as a state machine, software programs functioning with any of the previous types of hardware to act as a state machine, and a combination of the above. The controller is in communication with WAM transceiver 118, payload transceiver 120 and a data port interface. The data port interface is a data bus in the wireless device 102, such as a PCMCIA bus, PCI bus, serial data bus, parallel bus, SCSI bus, or even a network interface (802.3, token ring, etc. . . . ). The data port interface may pass data from computer memory (RAM, ROM, SDRAM, EEPROM etc. . . . ), disk drive (floppy, Compact Disk, hard disk drive, removable hard drive, DVD etc. . . . ), keyboards, mice, touch screens or other data storage or entry devices that can generate data for transmission over the AMC 104 of a WAM network 106 or a payload channel 108 over the first wireless network. The data port interface may also pass data from the AMC 104 or payload channel 108 to display devices such as monitors, LCD screens, printers, plotters, image capturing devices, etc. . . . Further, the controller processes the data that is received at and transmitted from the wireless device 102. The controller also processes control messages received from the WAM network 106.

The WAM architecture utilizes a secured and clear bandwidth (with about 0.5 MHz of continuous bandwidth) for the AMC. A single RF channel pair makes up the AMC 104 and operates at a predetermined time within each WAM cell. The forward channel is operated as a broadcast channel. In the forward direction, all wireless devices are listening within the WAM cell to the forward AMC RF frequency and receive the base station transmissions. In the reverse direction, the base station part of the WAM network 106 receives the transmission of the wireless device 102 that is transmitting at a predetermined times on the reverse AMC RF frequency. The reverse channel is operated as a time-domain multiple access (TDMA) channel. When collisions occur the wireless device 102 senses the collision and backs off a random amount of time before trying to gain access again. Each wireless device 102 may access a time slot in the reverse channel for transmission of control information and data. In an alternate embodiment, a plurality of time channels may be combined to increase the amount of data being transmitted from the wireless device 102 to the WAM network 106.

Transactions between the wireless device 102 and the WAM network 106 are divided into two main categories: user-initiated sessions and network-initiated sessions. These two categories are further subdivided as shown in Table 1.

TABLE 1
Network Transaction Types

| User Initiated | | Network Initiated | |
|---|---|---|---|
| Browsing | Time Critical | Broadcast | Alert |
| Similar to | Flight check-in | Traffic report | Incoming |
| desk-top | Money transfer | Advertising/promotions | e-mail |
| web-browsing | Stock purchase | Location-specific news | Update |
| | | and information | stock |
| | | Auction participation | quote |

Command-and-control information relating to user-initiated browsing sessions and network-initiated broadcast sessions (i.e. session-initiation, session management and session termination) are transported across the AMC, whereas the actual content is normally transported across the payload channel 108, particularly during peak traffic periods. The other two sub-categories, i.e., user initiated time critical and network-initiated alert sessions, the control as well as the payload information is carried across the AMC 104. One of the aspects of this approach is to ensure that the content providers need not rewrite their software while at the same time the user's look and feel is no different than experienced during a desktop session using wired facilities.

According to another embodiment, the AMC 104 is an always-available wireless access channel, and it carries all control packets including payload steering messages as well as about 75% or more of the up-link (wireless device 102 to WAM network 106) messages. A selection of bandwidth in the frequency range of 220 MHz-2 Ghz for the AMC 104 means that the propagation characteristics of the AMC 104 is comparable to existing cellular/Personal Communication Services (PCS) networks. Alternatively, narrowband PCS spectrum in combination with paging channels may be used for the required bandwidth.

The wireless device 102 with WAM network 106, to display an Internet home page, initiates a data session. The wireless device 102 discerns the “downlink” path (i.e., information or data from the network to the device) and the amount of data to identify the amount of spectrum required to transfer the data. The “uplink” information (from the wireless device 102 to WAM network 106) is carried on the AMC 104; with exceptions made when there are large payloads above a predetermined AMC threshold and requires a payload channel through another network, such as network 110. The AMC 104 or a payload channel 108 through another wireless network transports downlink information, based on the amount and/or type of information. Short, time-critical transactions or other information meeting predetermine criteria (i.e. type of data, size of data, secure data) are steered for transmission over the AMC 104.

In another embodiment, a determination is made by the wireless device 102 or the WAM network 106 to select a payload carrier and then another selection is made as to which wireless network 110 or 116 to set up the payload carrier through. The criteria for selection of the wireless network 110 or 116 may include time, bandwidth costs, subscriber preference, type of data, data security, and requesting application. In FIG. 1 only two networks are shown, but in other embodiments more than two wireless networks may be available to supply payload channels. The wireless networks may be any combination of public networks, private networks, and home based networks that may be accessed by wireless device 102.

Turning to FIG. 2, a block diagram of WAM network 106 within the wireless access management system 100, of FIG. 1 is shown. The wireless device 102 communicates with WAM network 106 and first wireless network 110. The WAM network 106 has a base station 202 that contains a transceiver for communicating over the AMC 104. The base station 202 is controlled from ACM manager 204 that is in communication with a payload carrier access manager 205 and a router 208. The router 208 is connected to the AMC manager 204, WAM server 206, the Remote Access Server (RAS) 210 and the Internet 112. The RAS 210 is connected to the router 208 and the first wireless network 110 through a data/voice network (PSTN 114). The first wireless network 110 may also be in communication with the wireless device 102 over payload channel 108.

The base station 202 is present in each cell of a WAM network 106 and performs data link or media access relay functions for the AMC 104 serving the WAM cell 212. In the forward direction, the base station 202 receives information from the AMC manager 204 and relays it over the AMC 104 to the wireless device 102. In the reverse direction, the base station 202 receives signals from the wireless device 102 within the WAM cell 212 over AMC 104 and relays them to the AMC manager 204. The wireless device 102 traveling from a WAM cell 102 to a neighboring WAM cell will result in a hand-over that is managed by the AMC manager 204 (similar to a cellular hand-over). In an alternate embodiment, a base station controller may control a number of base stations and handle the hand-overs that occur between base stations associated with that base station controller, while hand-over between base stations associated with different base station controllers will involve the AMC manager 204.

The AMC manager 204 performs base station management and can interface with a large number of base stations. The interface between the AMC manager 204 and base stations 202 uses the IP protocol, but other protocols may be used in alternate embodiments. Typically a dedicated 64K DSO, DSL or ISP dedicated line will be used for transmission of the IP protocol. The AMC manager 204 also implements other layers of the protocol for the AMC 104 as appropriate. It multiplexes outbound messages for the wireless device 102 currently registered in each associated WAM cell, such as WAM cell 212. Further, the AMC manager 204 processes registration and packet messages and then forwards the messages on to the router 208. The AMC manager 204 uses a frame relay protocol to interface to router 208. In alternate embodiments, the AMC manager 204 may interface to multiple routers that interface with multiple RASs. In yet another alternate embodiment, a PPP protocol is used to interface the AMC manager 204 with router 208, or a combination of frame relay and PPP may be used to interface the AMC manager 204 with a plurality of routers.

The wireless AMC manager 204 also contains a controller, such as a processor, digital signal processor, ASIC, discrete logic functioning as a state machine, analog circuit functioning as a state machine, software programs combined with hardware functioning as a state machine, and a combination of the above that is coupled to a AMC interface that formats (TDMA, CDMA, CDMA2000, etc. . . . ) the control messages and data for transmission over the AMC 104. The controller processes the data that is received at and transmitted to the wireless device 102. The control in the AMC manager 204 also monitors processes data from the wireless device 102 that indicates when a hand-over from base station 202 and another base station. Further, the controller also processes messages to and from the WAM server 206 via the router 208.

The WAM server 206 is used to configure, control and status the WAM network 106. The WAM server 206 may be integrated with the AMC manager 204 or a stand-alone server as shown in FIG. 2. Examples of server hardware manufactures include SUN MICROSYSTEMS, HP, DELL COMPUTER, and COMPAQ COMPUTER and may have UNIX, WINDOWS (NT,XP), or LINUX operating system. A network operator may interface with the WAM server 206 via a command-line interface running over a protocol such as telnet or more sophisticated graphical user interface. The WAM server 206 also collects accounting/billing information for each subscriber sessions set up by the AMC manager. Subscriber management is also located on WAM server 206 and manages the database of subscribers that includes an address associated with wireless device 102 that may access the WAM network 106.

The payload carrier access manager 205 is shown as a stand-alone server. In alternate embodiments, the payload carrier access manager 205 may co-located with the WAM server 206 or maybe co-located in the AMC manager 204 (with or without the WAM server 206). The payload carrier access manager 205 identifies the network that is to be used to transfer data to or from the wireless device 102 when a predetermined criteria is met. The selection by the payload carrier access manager 204 results in a carrier access identification being selected and sent to the AMC manager 204.

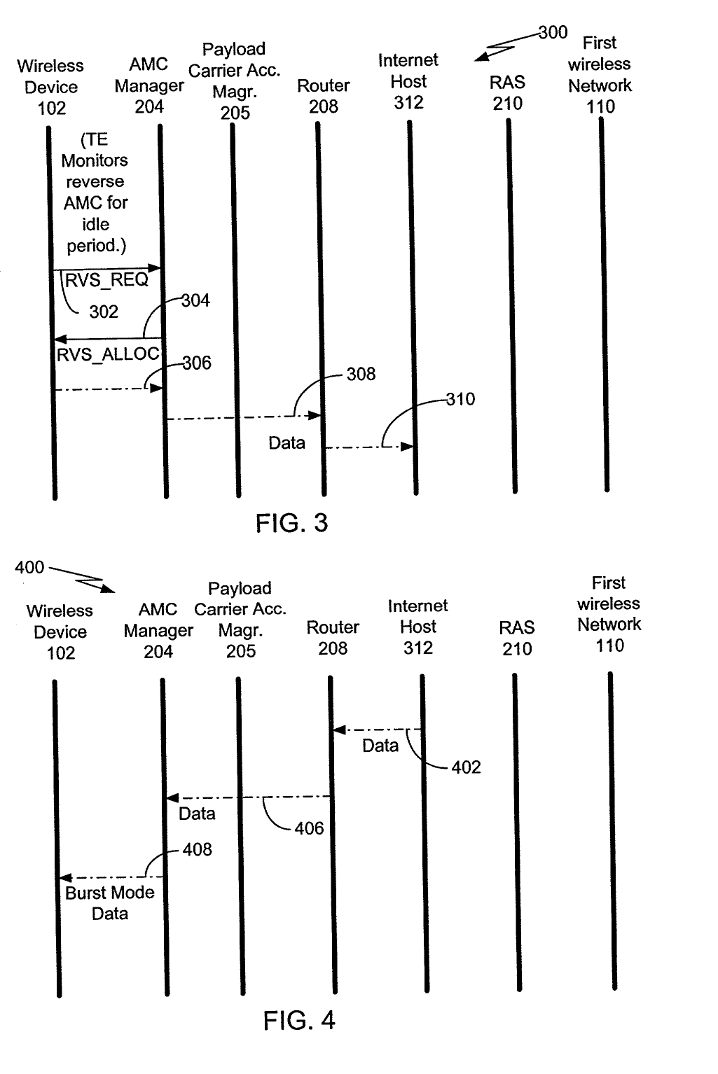

In FIG. 3, a message flow diagram 300 of a wireless device 102 initiating a burst mode data transfer in WAM network 106 of FIG. 2 is shown. A subscriber using the wireless device 102 causes an autonomous data transfer from the wireless device 102 to an Internet host 312 located in the Internet 112. For example, clicking on a web link of a web page displayed on the wireless device 102. When the wireless device 102 is ready to initiate a short data transfer it waits for an idle period on the reverse AMC 104. Upon an idle period being identified, the wireless device 102 sends a RVS_REQ message 302 to the AMC manager 204. The AMC Manager 204 responds to the received RVS_REQ message 302 by allocating bandwidth, for example a time slot, during which the wireless device 102 is allowed to transfer a burst mode message to the AMC manager 204. The AMC manager 204 then sends a RVS_ALLOC message 304 that includes an allocated bandwidth identifier associated with the allocated time slot to the wireless device 102. Once the time slot is allocated, the wireless device 102 sends data in a short burst message 306 to the AMC manager 204, which then sends the data in a message 308 to the router 208 that routes the data in message 310 to the appropriate Internet host 312.

Turning to FIG. 4, a message flow diagram 400 of an Internet host 312 initiated burst mode data transfer with wireless device 102 in a WAM network 106 of FIG. 2 is shown. The Internet host 312 initiates a transfer of data to the wireless device 102. This may be in response to a previous wireless device-initiated request or other third-party activity such as messaging. The data is sent in a message 402 from the Internet host 312 to the router 208. The router routes the message 406 to the AMC manager 204. The AMC manager 204 determines if the data transfer volume is below a certain AMC threshold, and if so, transmits a burst mode data message 408 containing the data from the received message 406 and also containing the address associated with wireless device 102 over the appropriate BTS 202 and AMC 104 to wireless device 102.

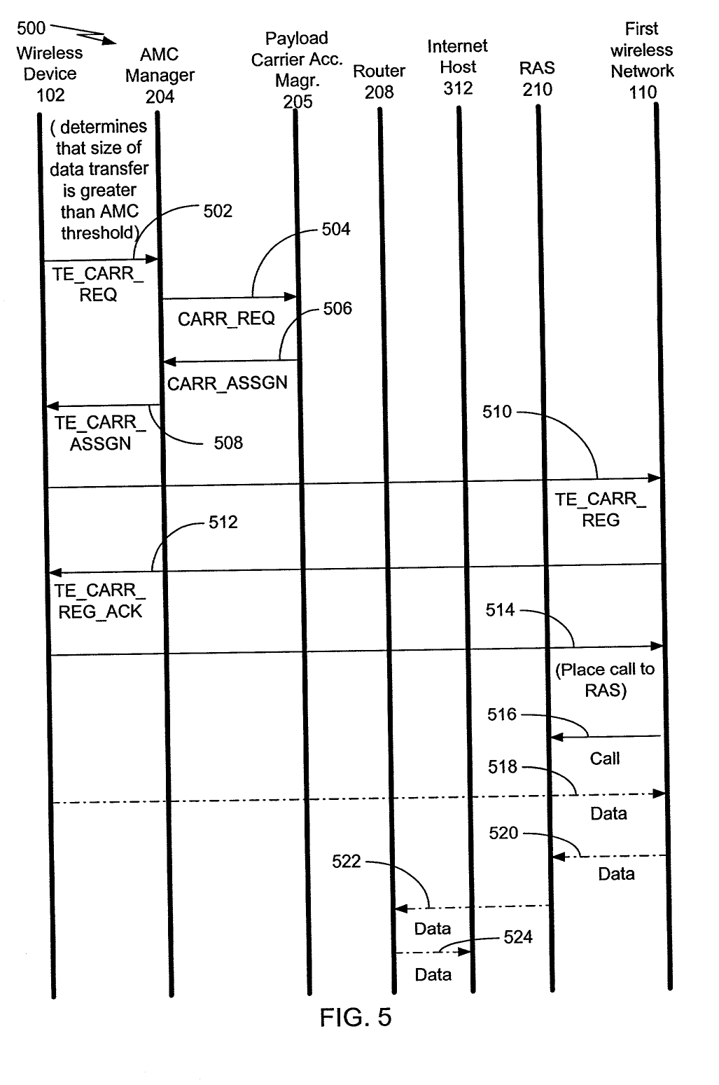

In FIG. 5, a message flow diagram 500 of a wireless device 102 initiated acquired bandwidth data transfer in WAM network 106 of FIG. 2 is shown. When the wireless device 102 determines that the amount of data to be transferred between the wireless device 102 and the Internet host 312 exceeds the AMC threshold, the transfer takes place via bandwidth acquired from a wireless network such as 110 or 116. The wireless device 102 makes the determination that the AMC threshold has been exceeded and sends the TE_CARR_REQ message 502 to the AMC manager 204 over the AMC 104 requesting a payload carrier from another network be assigned to transport the data. The AMC manager 204 requests from the payload carrier access manager 205 that the optimal access carrier (first wireless network 110 or second wireless network 116) to provide a payload channel by sending a CARR_REQ message 504. The optimal access carrier may be selected based on factors that include the capabilities of the wireless device 102 (i.e. has only modes that can communicate with the first wireless network), time of day, costs of access carrier, subscriber preferences, and availability of payload channels. In an alternate embodiment, a combination of factors may be used rather than an individual factor and a subscriber may have a combination of factors that is unique from another subscriber's combination of factors.

The payload carrier access manager 205 selects the carrier access identification (ID) and the address to be used on the wireless network 110 or 116 that is chosen (first wireless network 110 is chosen in FIG. 1). The payload carrier access manager 205 then sends the carrier access ID and the address associated with the first wireless network in a CARR_ASSGN message 506 to the ACM manager 204. The ACM manager 204 then sends a TE_CARR_ASSGN message 508 that containing the carrier access ID and the address associated with the first wireless network 110 to the wireless device 102.

The wireless device 102 then registers in the first wireless network using the address received from the AMC manager 203. The wireless device sending a TE_CARR_REG message 510 to the first wireless network 110 accomplishes registration. The first wireless network 110 then responds to the wireless device 102 with a TE_CARR_REG_ACK message 512 that indicates the wireless device 102 is registered in the first wireless network 110. The wireless device 102 then initiates the messaging 514 to set up a modem call to the RAS 210 over a payload channel using the type of signaling native to the first wireless network 110. The first wireless network 110 completes the modem call set up messaging 516 by termination the call at the RAS 210. Once the call path is set up via the payload channel 108, packets of data 518 are transferred directly from the wireless device through the first wireless network 110 and to the RAS 210 in message 520. The RAS 210 then sends data packets or messages to the router 208 and then to Internet host 312 in message 524. The same message flow would have been conducted with the second wireless network 116 replacing the first wireless network 110, if the payload carrier access manager 205 had selected the second wireless network 116. Thus, another advantage of the wireless access management system is the ability to steer data to the network that can most efficiently handle the data.

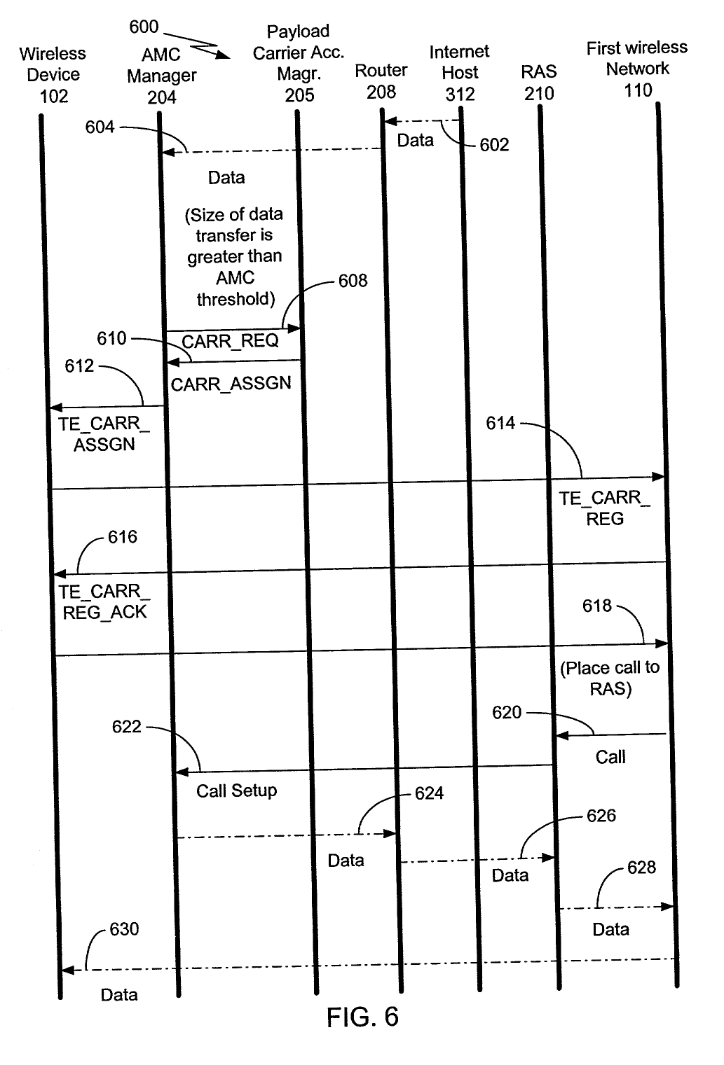

Referring to FIG. 6, a message flow diagram 600 of an AMC manager 204 initiated acquired bandwidth data transfer in WAM network 106 of FIG. 2 is shown. The Internet host 312 sends data 602 to the AMC manager 204 for transmission to the wireless device 102. The AMC manager 204 receives the data 604 and determines that the amount of data or required bandwidth exceeds the AMC threshold. The AMC manager 204 then initiates an acquired bandwidth data transfer session by sending a CARR_REQ message 608 to the payload carrier access manager 205 requesting an optimal access carrier. The subscriber manager identifies the optimal access carrier to provide the payload channel 108 as described in above and a CARR_ASSGN message 610 having an access carrier network ID (for the first wireless network 110 in the present example) and the address to be used on that network is returned from the payload carrier access manager 205 to the AMC manager 204.

The WAM manager 204 notifies the wireless access device 102 by sending over the AMC 104 a TE_CARR_ASSN message 612 that also contains the carrier network ID and the address. The wireless device 102 then sends a TE_CARR_REG message 614 to the first wireless network 110 to register in the first wireless network 110. The first wireless network 110 responds to the wireless device 102, with a TE_CARR_REG_ACK message 616 when the wireless device 102 is registered in the first wireless network 110.

The wireless device 110 then initiates the messaging 618 to place a modem call to the RAS 210 in the first wireless network 110 resulting in the assignment of a payload channel 108. The first wireless network 110 then communicates messages 620 to terminate the call at the RAS 210. Once the modem call is established, the RAS 210 notifies the AMC manager 204 with a call setup message 622.

The AMC manager 204 then routes the packets of data received from the router 208, back to the router 208 as packets of data 624. The router 208 then forwards the packets of data 626 to the RAS 210. The RAS 210 then send the data packets 628 to the first wireless network 110. The first wireless network 110 then send the data packets over the payload carrier 108 to the wireless device. The same message flow would have been conducted with the second wireless network 116 replacing the first wireless network 110, if the payload carrier access manager 205 had selected the second wireless network 116.

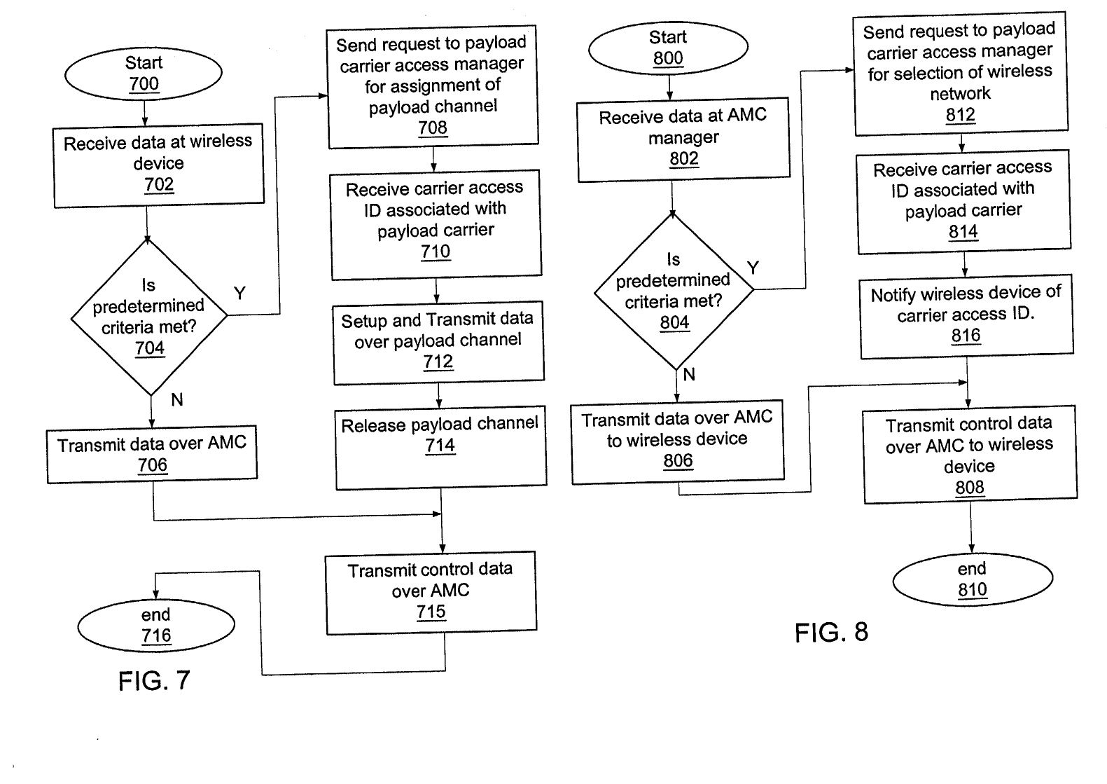

In FIG. 7, a flow diagram of the process of a wireless device 102 initiating an acquired bandwidth data transfer in WAM network of FIG. 2 is shown. The process starts (700) with data being received or generated at the wireless device 102 (702). The controller within the wireless device 102 processes the data and a predetermined criteria is compared with the processed data. If the predetermined criteria (as described previously) is not met, then the data is transmitted from the wireless device 102 over the AMC 104 to the AMC manager 204 (706). If the predetermined criteria (as described previously) is met (704), then a payload channel is required for the transmission of the data. The wireless device 102 transmits a request for assignment of a payload channel (708) across the AMC 104 to the AMC manager 204. The AMC manager 204 sends a request to the payload carrier access manager 205 for selection of a wireless network. The AMC manager 204 receives a carrier access ID associated with the payload carrier (wireless network) from the payload carrier access manager 205. The AMC manager 204, responds with a carrier access ID associated with the wireless network that is associated with the payload carrier (710). The wireless device 102 then establishes a path through the first wireless network 110 via payload channel 108 and the PSTN 114 to the RAS 210. Data is then transferred from the wireless device 102 to the Internet host 312 (712). Upon completion of the data transmission, the payload channel 108 is released (714). While the data is steered either to the AMC channel 104 or the payload channel 110, the control data or messaging is sent over the AMC 104 (715). Even though step (715) appears at the end of the process, it may occur simultaneously with data transmissions. Further, the procedure may be continuous but for illustration of the process, processing ends at step (716).

Turning to FIG. 8, a flow diagram of the process of an AMC manager 204 initiating an acquired bandwidth data transfer in WAM network 106 of FIG. 2 is shown. The process starts (800) and data is received by at the AMC manager 204 (802) from the Internet host 312 via the Internet 112. The AMC manager 204 determines if the data meets a predetermined criteria as described above (804). If the data does not meet the then the data or plurality of data packets are TDMA encoded and transmitted over the AMC 104 to the wireless device 102 (806). Other types of encoding such as CDMA, CDMA2000, GSM, AMPS, TACS, and other wireless protocols may be used in other embodiments. The control data or control messages are also sent over the AMC 104 to the wireless device 102 (808) and processing is complete (810).

If the predetermined criteria has been met, then the AMC manager 204 sends a request to the payload carrier access manager 205 for selection of a wireless network (812). The AMC manager 204 receives a carrier access ID associated with the payload carrier (wireless network) from the payload carrier access manager (814). The AMC manager 204, then notifies the wireless device 102 of the carrier access ID (816) by transmitting the data across the AMC 104. Simultaneously, step (808) is occurring and control data (control messages) are transmitted over the AMC 104 to wireless device 102 (808). The procedure may be continuous, but for illustration of the process, processing ends at step (810).

It is appreciated by those skilled in the art that the process shown in FIGS. 7 and 8 may selectively be implemented in hardware, software, or a combination of hardware and software. An embodiment of the process steps employs at least one machine-readable signal-bearing medium. Examples of machine-readable signal bearing mediums include computer-readable mediums such as a magnetic storage medium (i.e. floppy disks, or optical storage such as compact disk (CD) or digital video disk (DVD)), a biological storage medium, or an atomic storage medium, a discrete logic circuit(s) having logic gates for implementing logic functions upon data signals, an application specific integrated circuit having appropriate logic gates, a programmable gate array(s) (PGA), a field programmable gate array (FPGA), a random access memory device (RAM), read only memory device (ROM), electronic programmable random access memory (EPROM), or equivalent. Note that the computer-readable medium could even be paper or another suitable medium, upon which the computer instruction is printed, as the program can be electronically captured, via for instance optical scanning of the paper or other medium, then compiled, interpreted or otherwise processed in a suitable manner if necessary, and then stored in a computer memory.

Additionally, machine-readable signal bearing medium includes computer-readable signal bearing mediums. Computer-readable signal bearing mediums have a modulated carrier signal transmitted over one or more wire based, wireless or fiber optic networks or within a system. For example, one or more wire based, wireless or fiber optic network, such as the telephone network, a local area network, the Internet, or a wireless network having a component of a computer-readable signal residing or passing through the network. The computer readable signal is a representation of one or more machine instructions written in or implemented with any number of programming languages.

Furthermore, the multiple process steps implemented with a programming language, which comprises an ordered listing of executable instructions for implementing logical functions, can be embodied in any machine-readable signal bearing medium for use by or in connection with an instruction execution system, apparatus, or device, such as a computer-based system, controller-containing system having a processor, microprocessor, digital signal processor, discrete logic circuit functioning as a controller, or other system that can fetch the instructions from the instruction execution system, apparatus, or device and execute the instructions.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

I claim:

1. A wireless access management system, comprising:
a management network having an access management channel;
a wireless network having a control channel and a payload channel;
a wireless device having a wireless access management (WAM) transceiver that is able to exchange management network control information and data over the access management channel and a payload transceiver that is able to exchange wireless network control information over the control channel and data to the wireless device over the payload channel when steered by the management network in response to a predetermined criteria.

2. The system of claim 1, wherein the predetermined criteria is a predetermined bandwidth threshold.

3. The system of claim 1, wherein the predetermined criteria is a secure network request from the wireless device, wherein the secure network request is received at the management network.

4. The system of claim 1, further including:
a controller located in the wireless device in communication with the WAM transceiver and the payload transceiver that executes an instruction that results in transmission of data from the wireless device to the management network in response to the predetermined criteria.

5. The system of claim 1, further includes a database of subscriber information located in the management network that includes an entry associated with the wireless device.

6. The system of claim 5, wherein the database contains an identifier that results in the data being steered to the wireless network upon the predetermined criteria being meet.

7. A wireless apparatus, comprising:
a wireless access management (WAM) transceiver;
a payload transceiver;
a data port interface; and
a controller able to communicate with the WAM transceiver, the payload transceiver and the data port interface that identifies a predetermined criteria is meet upon receipt of a type of data at the data port interface that results in a control message being sent via the WAM transceiver that request the type of data be transmitted via the payload transceiver.

8. The wireless apparatus of claim 7, wherein the predetermined criterion is a predetermined bandwidth threshold.

9. The wireless apparatus of claim 8, wherein the type of data is streaming data.

10. The wireless apparatus of claim 7, wherein the predetermined criteria is a secure data request.

11. The wireless apparatus of claim 10, wherein the type of data is a private data type.

12. The wireless apparatus of claim 7, wherein the predetermined criteria is met by execution of an application by the controller.

13 The wireless apparatus of claim 7, wherein the WAM transceiver is a TDMA transceiver.

14. An access management channel manager apparatus, comprising:
an access management channel (AMC) interface;
a PSTN interface; and
a controller coupled to the AMC channel interface and PSTN interface that is able to send and receives a plurality of control messages and a plurality of data packets over the AMC interface and steers the plurality of data packets over the PSTN interface upon receipt of the plurality of data packets for transmission by the AMC interface and a predetermined criteria being meet.

15. The apparatus of claim 14, wherein the AMC interface generates a TDMA signal.

16. The apparatus of claim 14, wherein the predetermined criteria is associated with a predetermined bandwidth available to the AMC interface.

17. The apparatus of claim 14, wherein the predetermined criteria is associated with a type of data that may be carried in the plurality of data packets.

18. A method for wireless access management, comprising the steps of:
determining if a plurality of data to be transmitted meets a predetermined criteria;
transmitting the plurality of data and a plurality of control messages over an access management channel (AMC) in a management network in response to the predetermined criteria not being met; and
steering transmission of the plurality of data to a payload channel associated with a wireless network in response to the predetermined criteria being met while still sending the plurality of control messages over the AMC.

19. The method of claim 18, further comprising the step of selecting the wireless network from a plurality of wireless network based on the predetermined criteria.

20. The method of claim 18, where the step of transmitting further includes the step of TDMA encoding the plurality of data and the plurality of control message that are transmitted in the management network.

21. The method of claim 18, where the step of determining further includes the step of identifying a type of data associated with the plurality of data at a wireless device.

22. The method of claim 21, where the step of identifying further includes the step of determining an amount of data associated with the plurality of data.

23. The method of claim 18, where the step of determining further includes the step of identifying a type of data associated with the plurality of data at an access management channel manager.

24. The method of claim 23, where the step of identifying further includes the step of determining an amount of data associated with the plurality of data.

25. The method of claim 18, where the step of determining further includes the step of identifying a request in the plurality of data to use the payload channel in the wireless network as the predetermined criteria.

26. A method of wireless access management at a wireless device, comprising the steps of:
transmitting a plurality of control data and a plurality of data over an access management channel (AMC) via a WAM transceiver when the plurality of data does not meet a predetermined criteria; and
steering the plurality of data over a payload channel via a payload transceiver upon the predetermined criteria is met.

27. The method of claim 26, where the step of steering further includes the step of sending in the plurality of control data a payload channel request over the AMC via the WAM transceiver.

28. The method of claim 27, wherein the step of steering further includes the step of receiving via the WAM transceiver a carrier access ID associated with the payload channel over.

29. The method of claim 28, further including the step of identifying an amount of data from the plurality of data, and
comparing the amount of data to the predetermined threshold to determine if the predetermined criteria is met.

30. The method of claim 28, where the step of transmitting further includes the step of TDMA encoding the plurality of control data for transmission in the WAM transceiver.

31. The method of claim 26, further comprising the step of executing by a controller an application that requires a payload channel and results in the predetermined criteria being met.

32. A method of wireless access management at an access management channel (AMC) manager, comprising the steps of:
transmitting a plurality of control data and a plurality of data over an access management channel (AMC) when the plurality of data does not meet a predetermined criteria; and
establishing a PSTN connection to steer the plurality of data to a wireless network when the predetermined criteria is met.

33. The method of claim 32, wherein the step of establishing further includes the step of sending a carrier access ID associated with the payload channel in a control data message from the plurality of control data over the AMC.

34. The method of claim 32, further including the step of identifying an amount of data from the plurality of data, and
comparing the amount of data to the predetermined threshold to determine if the predetermined criteria is met.

35. The method of claim 32, where the step of transmitting further includes the step of TDMA encoding the plurality of control data for transmission over the AMC.

36. A signal bearing medium having machine-readable instructions for wireless access management, comprising:
a first machine-readable instruction set for determining if a plurality of data to be transmitted meets a predetermined criteria;
a second machine-readable instruction set for transmitting the plurality of data and a plurality of control messages over an access management channel (AMC) in a management network in response to the predetermined criteria not being met; and
a third machine-readable instruction set for steering transmission of the plurality of data to a payload channel associated with a wireless network in response to the predetermined criteria being met while still sending the plurality of control messages over the AMC.

37. The signal bearing medium of claim 36, further comprising a fourth machine-readable instructions set for selecting the wireless network from a plurality of wireless network based on the predetermined criteria.

38. The signal bearing medium of claim 36, wherein the second machine-readable instruction set further includes a machine-readable instruction set for TDMA encoding the plurality of data and the plurality of control message that are transmitted in the management network.

39. The signal bearing medium of claim 36, wherein the first machine-readable instruction set further includes a machine-readable instruction set for identifying a type of data associated with the plurality of data at a wireless device.

40. The signal bearing medium of claim 39, wherein the machine-readable instruction set for identifying further includes a machine-readable instruction set for determining an amount of data associated with the plurality of data.

41. The signal bearing medium of claim 36, wherein the first machine-readable instruction set further includes a machine-readable instruction set for identifying a type of data associated with the plurality of data at an access management channel manager.

42. The signal bearing medium of claim 41, wherein the machine-readable instruction set for identifying further includes a machine-readable instruction set for determining an amount of data associated with the plurality of data.

43. The signal bearing medium of claim 36, wherein the first machine-readable instruction set further includes a machine-readable instruction set for identifying a request in the plurality of data to use the payload channel in the wireless network as the predetermined criteria.

44. A signal bearing medium having machine-readable instructions for wireless access management at a wireless device, comprising:
a first machine-readable instruction set for transmitting a plurality of control data and a plurality of data over an access management channel (AMC) via a WAM transceiver when the plurality of data does not meet a predetermined criteria; and
a second machine-readable instruction set for steering the plurality of data over a payload channel via a payload transceiver upon the predetermined criteria is met.

45. The signal bearing medium of claim 44, wherein the second machine-readable instruction set further includes a machine-readable instruction set for sending in the plurality of control data a payload channel request over the AMC via the WAM transceiver.

46. The signal bearing medium of claim 45, wherein the second machine-readable instruction set further includes a machine-readable instruction set for receiving via the WAM transceiver a carrier access ID associated with the payload channel over.

47. The signal bearing medium of claim 46, further including a third machine-readable instruction set for identifying an amount of data from the plurality of data, and a fourth machine-readable instruction set for comparing the amount of data to the predetermined threshold to determine if the predetermined criteria is met.

48. The signal bearing medium of claim 45, the first machine-readable instruction set further includes a machine-readable instruction set for TDMA encoding the plurality of control data for transmission in the WAM transceiver.

49. A wireless apparatus, comprising:
means for transmitting a plurality of control data and a plurality of data over an access management channel (AMC) via a WAM transceiver when the plurality of data does not meet a predetermined criteria; and
means for steering the plurality of data over a payload channel via a payload transceiver upon the predetermined criteria is met.

50. The apparatus of claim 49, where the means for steering further includes means for sending in the plurality of control data a payload channel request over the AMC via the WAM transceiver.

51. The apparatus of claim 50, wherein the means for steering further includes a means for receiving via the WAM transceiver a carrier access ID associated with the payload channel over.

52. The apparatus of claim 51, further including means for identifying an amount of data from the plurality of data, and means for comparing the amount of data to the predetermined threshold to determine if the predetermined criteria is met.

53. The apparatus of claim 49, where the step of transmitting further includes the means for TDMA encoding the plurality of control data for transmission in the WAM transceiver.

54. The apparatus of claim 49, further comprising means for executing an application that requires a payload channel and results in the predetermined criteria being met.

55. An access management channel (AMC) manager apparatus, comprising:
means for transmitting a plurality of control data and a plurality of data over an access management channel (AMC) when the plurality of data does not meet a predetermined criteria; and
means for establishing a PSTN connection to steer the plurality of data to a wireless network when the predetermined criteria is met.

56. The apparatus of claim 55, wherein establishing means further includes means for sending a carrier access ID associated with the payload channel in a control data message from the plurality of control data over the AMC.

57. The apparatus of claim 55, further including means for identifying an amount of data from the plurality of data, and
means for comparing the amount of data to the predetermined threshold to determine if the predetermined criteria is met.

58. The apparatus of claim 55, where transmitting means further includes means for TDMA encoding the plurality of control data for transmission over the AMC.
